(19) United States
(12) Patent Application Publication
(10) Pub. No.: US 2007/0193986 A1
(43) Pub. Date: Aug. 23, 2007

(54) Method for producing boreholes

(76) Inventors: Wolfgang Schulz, Langerwehe (DE); Jens Willach, Aachen (DE); Jochen Petereit, Aachen (DE); Lena Trippe, Aachen (DE); Ernst Wolfgang Kreutz, Grevenbroich (DE)

Correspondence Address: MILDE & HOFFBERG, LLP, 10 BANK STREET, SUITE 460, WHITE PLAINS, NY, 10606, US

(21) Appl. No.: 10/594,052

(22) PCT Filed: Mar. 23, 2005
(86) PCT No.: PCT/EP05/03310

§ 371 Date: Nov. 24, 2006

(30) Foreign Application Priority Data
Mar. 24, 2004 (DE) 10 2004 014 820.1

(51) Int. Cl. B23K 26/00

(52) U.S. Cl. 219/121.71

(57) ABSTRACT

The invention relates to a method for producing boreholes with a large aspect ratio, in metallic materials, layered metallic materials and materials comprising at least one ceramic layer, by means of laser radiation, the intensity of the laser beam being adjusted according to the required modification of the borehole radius in relation to the borehole depth. The spatial distribution of the intensity of the laser beam, in relation to the changing bottom of the borehole, is adjusted in such a way that the intensity I inside the segment w₀ at a distance w from the laser beam axis falls off monotonously by the value ΔI, and values are set for the spatial modification ΔI of the intensity I and for the segment w₀ that are high enough that the borehole radius r_{B} is larger than the segment w₀, which is the radius of the laser beam (r_{B}>w₀).

The present invention relates to a method for producing boreholes with a large aspect ratio, in metallic materials, layered metallic materials, and materials comprising at least one ceramic layer, by means of laser radiation, the intensity of the laser beam being adjusted according to the required modification of the borehole radius in relation to the borehole depth.

Laser radiation is particularly used for removing and drilling metallic materials and composite materials of dielectric (e.g. ceramic) and metallic layers. High removal rates (high productivity) and large aspect ratios (depth in relation to diameter) are desired particularly for applications in automotive engineering, aviation engineering (fine-sized or medium-sized sheet) and energy engineering (medium-sized sheet). The geometrical shape of the borehole (e.g. cylindrical, conical) and the morphology of the borehole wall (e.g. solidified melt) are essential quality features and are subject to given technical requirements.

The known techniques for drilling with laser radiation are divided by the dominant mechanism for ejecting the material during drilling—melting, vaporization—into two groups:

Drilling Techniques With Dominant Melt Ejection

Drilling techniques with dominant melt ejection are single pulse drilling, percussion drilling (multi-pulse) and trepanning. These techniques have the advantage of high removal rates (productivity) and the drawback of a poor quality due to incomplete melt ejection, deposits of solidified melt on the borehole wall and/or on the borehole entrance and exit, and poor precision with respect to the borehole diameter. With trepanning, a percussion borehole is first introduced into the material and a hole with a defined radius is then cut out. Trepanning has the drawback that the major part of evolving melt is ejected by a process gas stream at the borehole exit, and the interior of a hollow body to be drilled gets soiled thereby.

The prior art describes a variety of measures that aim at an ejection of the melt that is as complete as possible, and at obtaining a defined, mostly cylindrical, shape of the borehole. These measures are increasing the spatial mean value or the maximum value of the intensity in the laser beam with an increasing depth of the borehole

modulation in time (percussion) of the intensity with a large number of single pulses during the whole drilling period.

Percussion drilling is only used in industry if the poor quality (incomplete melt ejection, adhering solidified melt, poor precision of the borehole shape) does not limit the function of the product.

According to the prior art dealing with single pulse drilling and percussion drilling the intensity is enhanced with an increasing depth of the borehole so as to compensate, for instance, for the impact of a beam expansion. The intensity is modulated to change the required diameter of the borehole, for instance, by varying the ratio of the pulse duration to the interval between two pulses.

According to EP 0 796 695 A1 the exit diameter of the borehole, which is normally smaller than the diameter of the upper part of the borehole, can be enlarged if the temperature of the workpiece is at least 25° C. above the ambient temperature.

Drilling Techniques with Dominant Vaporization

The techniques helical drilling, percussion drilling and laser erosion are used for drilling by dominant vaporization.

Up to now the geometrical shape required for the borehole can only be achieved in a selective way by helical drilling or a combination of percussion drilling and helical drilling.

According to DE 101 44 008 A1 a percussion borehole produced by predominant melt ejection can be expanded to the desired diameter in a second process step by dominant removal as vapor so that no residues of solidified melt remain on the borehole wall. This high-precision drilling technique and also variants thereof have the drawback of an excessively long drilling period or poor productivity.

DE 699 03 541 T2 describes an apparatus and a method for drilling so-called microvia holes in “electrical circuit interconnection packages”. The microvia holes are holes formed in printed circuit boards by means of laser radiation. It is the purpose of such holes to contact individual conductor layers in printed circuit boards through the holes. These holes are of the type having a very small aspect ratio. In these microvia boreholes, the borehole diameter should be equal to the laser beam diameter. Even if the borehole should become slightly larger, this is not desired. According to this publication the edge of the intensity distribution is regarded as the parameter that defines the borehole edge and is essential since the intensity distribution of the beam is annularly shaped.

It is now the object of the present invention to eliminate the above-mentioned deficiencies in the prior art and to develop the method outlined at the outset in such a manner that complete ejection of the melt is particularly ensured during drilling in the direction of the incident laser beam radiation from the borehole duct without any deposits of solidified melt on the borehole edge.

Starting from the method with the above-indicated features, this object is achieved in that the spatial distribution of the intensity of the laser beam, in relation to the changing bottom of the borehole, is adjusted in such a way that the intensity I inside the segment (distance) w₀ at a distance w from the laser beam axis falls by the value ΔI, said drop occurs monotonously, and values are set for the spatial modification ΔI of the intensity I and for the segment w₀ that are so high that a borehole radius r_{B} (r_{B}>w₀) is larger than the segment w₀, the segment w₀ being the radius of the laser beam. Hence, the segment w₀ is the radius of an area perpendicular to the laser beam axis covering 86% of the laser power.

With this measure of the method, the conventional technique of single pulse drilling and percussion drilling with laser radiation with dominant melt ejection is designed such that a complete ejection of the melt out of the borehole is possible without any melt depositing on the borehole wall. In the former known methods, melt ejection is controlled via laser-induced plasma through the spatial mean value or the maximum value of the intensity in the laser beam, which does not permit a selective control of the borehole diameter and does not prevent melt deposits. A second method step for smoothing the borehole wall by vaporization ablation, as is described in DE 101 44 008 A1, is not needed.

The method according to the invention is used to produce boreholes of a very great depth, i.e. boreholes with a “large aspect ratio”. This large aspect ratio of the boreholes and the provison that the borehole diameter should be much larger than the laser beam radius ensure that the rising melt does not shade the laser beam. For the spatial modification ΔI of intensity I and for the segment w₀ the values are set to be so high that a borehole radius r_{B} (r_{B}>w₀) larger than segment w₀ is achieved. ΔI and w₀ are chosen to be so great that the borehole gets wide enough to ensure the above-indicated effect, viz. not to shade the laser beam by the rising melt.

The boreholes are given a conical shape and it is also ensured that at every depth a predefined borehole radius can be adjusted.

Preferred embodiments of the method become apparent from the subclaims.

Hence, the method according to the invention permits a selective adjustment of the borehole diameter also during the drilling process. Below a defined aspect ratio of borehole depth to borehole diameter it is also possible to achieve any desired diameters with high precision in dependence upon the depth, and it is possible to produce cylindrical, conical and other geometrical shapes of the borehole.

Essential features which must be reliably achieved in melt drilling are

Reproducible Diameter:

The smallest diameter of a borehole defines the volume flow. The total flow volume of fuel filters is added up from the flow volume of the individual boreholes that are defined by the respectively minimal diameters of the boreholes.

Defined Conicity:

The flow behavior upon exit of gases and liquids out of the borehole is inter alia defined by the angle of the borehole wall relative to the material surface and the expansion of the borehole. The defined conicity is e.g. decisive for the distribution of cooling gases on material surfaces for the protection of turbine components.

Defined Conicity During Drilling of Multilayer Systems:

The cylindrical or conical borehole geometry is a precondition for the laminar flow of liquids and gases into the borehole. It must be possible to regulate the diameter of boreholes in turbine components—e.g. multilayer systems, consisting of the substrate, the adhesive agent layer and the thermal insulation layer—independently of the material layer.

No Reduction of the Adhesion and Shearing Strength of Coatings:

During the drilling of multilayer systems the adhesion between the layers in the area of the borehole must not be diminished. Upon damage of the thermal insulation layer of turbine components the layers of the components, which are subjected to great thermal and mechanical loads during operation, may detach from the material, and protection is no longer guaranteed.

No Deposits of Solidified Melt:

A defined borehole diameter can only be achieved if the geometrical shape of the borehole is not changed by irregular deposits of solidified melt on the borehole wall. In the solidified melt cracks and stresses may be created. With components subjected to great loads, such as turbine blades and fuel filters, the prevention of deposits of solidified melt enhances the service life of such components.
No Formation of Burrs:

A burr of solidified melt at the borehole exit increases, for instance, the flow resistance, whereby the efficiency is diminished. No finishing operation is needed when the formation of burrs is prevented, whereby the production period of e.g. turbine components and fuel filters is reduced.
Ejection of the Melt in the Direction of the Incident Laser Radiation:

The outflow of the melt in upward direction out of the borehole reduces contamination in hollow bodies. When fuel filters and turbine blades are manufactured, a finishing operation (cleaning) is needed if material residues deposit in the hollow bodies during drilling.
Large Curvature of the Exit Edge:

The separation of a liquid flow at the borehole opening is determined by the curvature of the exit edge. In injection nozzles the curvature of the exit edge is decisive for the separation and the complete combustion of the fuel in the combustion chamber.

The intake of ambient gases into the borehole or the separation of a cooling gas flow from the exit of a cooling borehole in turbine blades are undesired characteristics of the flow, the formation of which depends on the geometrical shape of the exit edge.

It is important for the invention that the spatial distribution of the intensity in the laser beam on the borehole bottom has to be set in an appropriate manner as the decisive parameter for the complete melt ejection over a predetermined depth of the borehole and not, as known in former times, the spatially averaged value or the maximum value of the intensity I₀ in the laser beam. What is characteristic is an appropriate spatial distribution of the laser radiation over an adequately large segment w₀ in the laser beam within which the intensity drops with the distance from the laser beam axis and an adequately great spatial modification of the intensity (intensity gradient) is present.

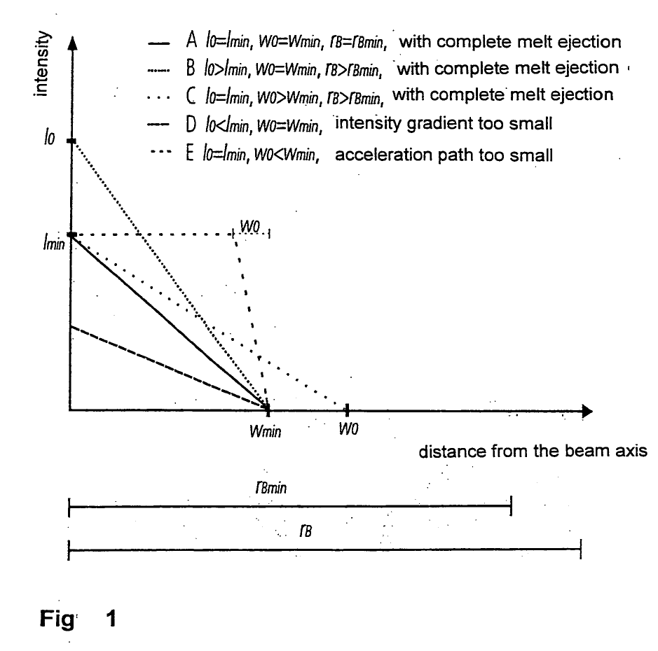

The attached FIG. 1 sketches the minimum values for the intensity I₀=Iₘᵢₙ and the distance or segment w₀=wₘᵢₙ, case A being applicable to the above.

In a preferred measure, the segment w₀ is set to be approximately in proportion to the root of the predefined borehole depth 1 to be achieved.

Furthermore, the spatial modification ΔI of the intensity I inside segment w₀ should be adjusted approximately in proportion to the predefined borehole depth 1 or the borehole depth 1 to be achieved in such a manner that a borehole radius r_{B} (r_{B}>w₀) larger than segment w₀ is obtained.

The maximum aspect ratio α of borehole depth 1 to borehole diameter d and the minimum diameter dₘᵢₙ>1/α(dₘᵢₙ=2r_{Bmin}) of the borehole should be set according to the following rule
α<const. ΔI w₀
the spatial modification ΔI=I₀−I_{w0} being the intensity I inside segment w₀, and I₀ being the intensity on the laser beam axis and I_{w0} the intensity at a distance w₀ from the laser beam axis.

For enlarging the borehole diameter d (=2r_{B}) during drilling the maximum value I₀>Iₘᵢₙ for the intensity is controlled or regulated such that the borehole diameter d (=2r_{B}) reaches a predefined, depth-dependent value d>dₘᵢₙ, I₀ being the intensity on the laser beam axis and Iₘᵢₙ the minimum value of intensity I₀.

Furthermore, it is essential that after an appropriate adjustment of the spatial distribution of the intensity on the borehole bottom the minimum borehole diameter 2r_{Bmin} and the maximum aspect ratio of borehole depth to borehole diameter are determined. To this end FIG. 1, case A, shows the corresponding values (I₀=Iₘᵢₙ, w₀=wₘᵢₙ).

To achieve an increase in the borehole diameter 2r_{B}>2r_{Bmin} also during the drilling process, the maximum value for the intensity I₀>Iₘᵢₙ and/or segment w₀>wₘᵢₙ must be controlled. Any desired larger diameter can e.g. be achieved by increasing the intensity (see FIG. 1, case B) or the segment (see FIG. 1, case C) over which the melt is accelerated on the borehole bottom.

Cylindrical and conical borehole geometries are adjustable with reproducible quality by setting the spatial distribution of the intensity on the borehole bottom and controlling the borehole diameter, as has been indicated above.

As can further be seen with reference to FIG. 1, deviations from the above-indicated rules, e.g. in cases where the intensity gradient is too small (see FIG. 1, case D) and/or where segment w₀ is too small within which the intensity in the laser beam drops (see FIG. 1, case E), lead to an incomplete melt ejection. In comparison with the above-indicated rules smaller borehole diameters can be accomplished e.g. with an almost rectangular distribution of the intensity (see FIG. 1, case E). This, however, violates the rule regarding the adjustment of the spatial distribution of the intensity on the borehole bottom, and the quality of the borehole deteriorates because the melt cannot be ejected completely.

When multilayer systems are being drilled, i.e. during drilling of different material layers, the different material characteristics are taken into account in the selection of the appropriate intensity distribution for realizing defined borehole diameters, so that particularly during transition from one material layer to the next one adaptations have to be carried out in the intensity distribution. The transition between two layers can be observed through changes in the process emission (e.g. plasma lighting) and can be detected by coaxial or lateral high-speed photography.

In a preferred process sequence the outflowing melt is additionally heated in an appropriate manner along the borehole wall.

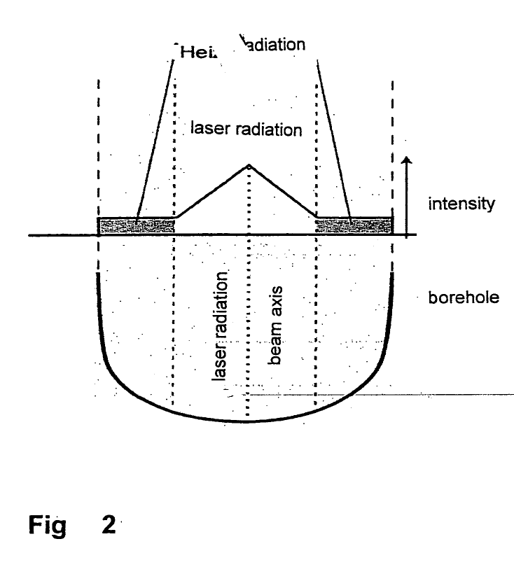

To this end FIG. 2 of the attached drawing schematically shows the distribution of the intensity in the laser beam and the arrangement of the additional heating sources.

Attention must be paid that, as soon as the set borehole diameter 2r_{B} has been reached, additional heating of the borehole wall must start, and the heating power must increase with the drilling depth.

Attention should be paid that the heating source is operative inside the borehole, if possible, only the flowing melt is heated, and that the primary energy source (drilling laser beam) is not affected (e.g. absorption of drilling laser radiation in the drilling channel) and that the central portion of the borehole remains as unaffected as possible.

As can be seen from FIG. 2, the spatial action of the energy sources should be distributed over the borehole diameter such that the borehole bottom reaches an adequately large width 2r_{B} that is larger than width 2w₀ of the drilling laser beam within which the intensity in radial direction drops approximately monotonously, and that the borehole wall is heated.

In a preferred measure, the heat radiation is generated by beam shaping in the resonator such that the intensity of the laser beam is annularly irradiated onto the borehole for heating the borehole wall. The heat radiation can thereby be generated by exciting higher modes at least after the predefined borehole diameter has been reached. It is also possible to generate the heat radiation by way of apertures, the central portion of the laser beam being then masked.

An alternative possibility consists in shaping the laser radiation for heating the melt flowing out of the borehole by an optical component outside the resonator in such a manner that a central portion of the laser beam produces the predetermined borehole diameter and an annular outer portion of the laser beam is irradiated onto the borehole heating the borehole wall. An axicon may be used as the optical component outside the resonator.

The heat radiation for heating the melt flowing out of the borehole may also be coupled into the borehole via a second source of energy in the form of thermal energy. The heat radiation may take place via a plurality of annularly arranged diode lasers, via a thermal light source, with a halogen lamp, an arc lamp or a vapor lamp being possibly used as the thermal light source.

The heat radiation may also be produced via a laser beam source, the generated plasma acting as a secondary heat source on the wall of the borehole.

For generating the heat radiation the same laser beam source may be used as the one used for drilling.

The heat radiation may be controlled by signal feedback from a coaxial or lateral high-speed photograph.

Of the above-indicated measures for heating the borehole wall, preference should particularly be given to annularly arranged diode lasers or thermal light sources because the heating action and operative range can be flexibly adjusted for the annularly arranged diode lasers, or the thermal efforts taken for realizing the apparatus used for heating are small for the thermal light sources.

The control of the heat radiation, e.g. by laser-induced plasma, can be realized just like the control of the ablating laser radiation in multilayer systems, including coaxial or lateral process monitoring, for instance by way of high-speed photography or short-term spectroscopy.

The invention can be used whenever in the case of single pulse drilling or percussion drilling with laser radiation the predominant part of the material is ejected in the liquid phase (melt).

In energy and aviation engineering, cooling boreholes in turbine components are introduced with the percussion drilling technique to additionally protect the components of high-temperature resistant materials with ceramic thermal insulating layers (multilayer systems) against the great thermal loads. To enhance efficiency even further, an improved distribution of the cooling air on the surfaces of the turbine blades and the combustion chamber plates is required. This can only be accomplished through a defined borehole geometry (cylindrical and/or conical) and a larger number of boreholes per cm² (up to 100 boreholes/cm² instead of 0.75 boreholes/cm² at the moment). However, the drilling duration (e.g. trepanning) is too long and the presently achieved aspect ratio with varying borehole geometry is not adequate to accomplish a significant increase in efficiency only by raising the number of the boreholes per cm². Moreover, the prevention of deposits of solidified melt in the borehole duct and burr formation is of essential importance so as not to cause any change in the geometrical shape of the borehole that is preferred under technical flow aspects.

In automotive engineering, fuel filters are drilled with laser radiation while small demands are made on precision. In the case of boreholes determining flow and spray conditions in injection valves, throttles or nozzles, deviations from the standard geometry of a few μm and thicknesses just as small of the melt deposits, as well as sharp-edged borehole entrances and exits with very large curvatures, are demanded.

The above requirements can be met with the method according to the invention.

What is claimed is:

1. A method for producing boreholes with a large aspect ratio, in metallic materials, layered metallic materials and materials comprising at least one ceramic layer, by means of laser radiation, the intensity of the laser beam being adjusted according to the required modification of the borehole radius in relation to the borehole depth, the improvement wherein the spatial distribution of the intensity of the laser beam, in relation to the changing bottom of the borehole, is adjusted in such a way that the intensity I inside the segment w₀ at a distance w from the laser beam axis falls by the value ΔI, said drop occurs monotonously, and values are set for the spatial modification ΔI of the intensity I and for the segment w₀ that are so high that a borehole radius r_{B} (r_{B}>w₀) is larger than the segment w₀, the segment w₀ being the radius of the laser beam.

2. The method according to claim 1, wherein the segment w₀ is set approximately in proportion to the root of the predefined borehole depth 1 to be achieved.

3. The method according to claim 1, wherein the spatial modification ΔI of intensity I is set approximately in proportion to the predefined borehole depth 1 to be achieved.

4. The method according to claim 3, wherein the maximum aspect ratio α of borehole depth 1 to borehole diameter d and the minimum diameter dₘᵢₙ>1/α (dₘᵢₙ=2r_{Bmin}) of the borehole are set by the following rule
α<const. Δ w₀,
the spatial modification ΔI=I₀—Iw₀ being intensity I within the segment w₀, and I₀ being the intensity on the laser beam axis and I_{w0} the intensity at the distance w₀ from the laser beam axis.

5. The method according to claim 1, wherein for enlarging the borehole diameter d (=2r_{B}) during drilling the maximum value I₀>Iₘᵢₙ for the intensity is controlled or regulated such that the borehole diameter d (=2r_{B}) reaches a predetermined depth-dependent value d>dₘᵢₙ, I₀ being the intensity on the laser beam axis and Iₘᵢₙ the minimum value of intensity I₀.

6. The method according to claim 1, wherein for enlarging the borehole diameter d (=2r_{B}) during drilling the segment w₀>wₘᵢₙ is controlled or regulated such that the borehole diameter d (=2r_{B}) reaches a predetermined depth-dependent value d>dₘᵢₙ, w₀ being the radial distance from the laser beam axis and wₘᵢₙ the minimum distance from the laser beam axis over which the spatial modification ΔI takes place.

7. The method according to claim 1, wherein when different material layers are drilled the intensity distribution of the laser radiation is adapted during transition from one layer of material to the next one in such a manner that the same or the predetermined depth-dependent borehole diameter is achieved in both material layers.

8. The method according to claim 7, wherein the transition between two material layers is monitored by changing the process emissions.

9. The method according to claim 8, wherein the change in the process emissions is detected by coaxial or lateral high-speed photography.

10. The method according to claim 1, wherein when a set borehole diameter d (=2r_{B}) is reached the borehole wall is heated in addition.

11. The method according to claim 10, wherein the additional heating is increased with an increasing depth of the borehole.

12. The method according to claim 10 wherein the additional heating is limited to the melt flowing out of the borehole.

13. The method according to claim 12, wherein heat radiation is generated through beam shaping in the resonator in such a manner that the intensity of the laser beam is annularly irradiated onto the borehole for heating the borehole wall.

14. The method according to claim 13, wherein the heat radiation is generated by excitation of higher modes at least after the predetermined borehole diameter has been reached.

15. The method according to claim 13, wherein the heat radiation is generated by way of apertures, the central portion of the laser beam being masked.

16. The method according to claim 12, wherein the laser radiation is shaped by an optical component outside the resonator such that a central portion of the laser beam produces the predetermined borehole diameter and an annular outer portion of the laser beam is irradiated onto the borehole for heating the borehole wall.

17. The method according to claim 16, wherein an axicon is used as the optical component outside the resonator.

18. The method according to claim 12, wherein heat radiation is coupled into the borehole via a second source of energy in the form of thermal energy.

19. The method according to claim 12, wherein heat radiation is generated via a plurality of annularly arranged diode lasers.

20. The method according to claim 12, wherein heat radiation is generated via a thermal light source.

21. The method according to claim 20, wherein a halogen lamp is used as the thermal light source.

22. The method according to claim 20, wherein an arc lamp is used as the thermal light source.

23. The method according to claim 20, wherein a vapor lamp is used as the thermal light source.

24. The method according to claim 12, wherein heat radiation is generated via a laser beam source, the generated plasma acting as a secondary heat source on the wall of the borehole.

25. The method according to claim 24, wherein the same laser beam source as the one used for drilling is used for generating the heat radiation.

26. The method according to claim 13, wherein the control of the heat radiation is detected by coaxial or lateral high-speed photography.
